(19) United States
(12) Patent Application Publication
(10) Pub. No.: US 2017/0023724 A1
(43) Pub. Date: Jan. 26, 2017

(54) Optical Module And Reflective Display Apparatus

(71) Applicant: BOE Technology Group Co., Ltd., Beijing (CN)

(72) Inventors: Guangkui Qin, Beijing (CN); Xinxing Wang, Beijing (CN); Ming Zhu, Beijing (CN); Zezhou Yang, Beijing (CN); Jifeng Tan, Beijing (CN)

(73) Assignee: BOE Technology Group Co., Ltd., Beijing (CN)

(21) Appl. No.: 15/124,379

(22) PCT Filed: Jun. 9, 2015
(86) PCT No.: PCT/CN2015/081056

§ 371 Date: Sep. 8, 2016

(30) Foreign Application Priority Data
Dec. 30, 2014 (JP) 201410843668.2

(51) Int. Cl. F21V 8/00

(52) U.S. Cl. CPC G02B 6/0053; G02B 6/0051; G02B 6/0056; G02B 6/0088

(57) ABSTRACT

The present disclosure provides an optical module and a reflective display apparatus that relate to the technical field of display and may improve the display effects in a dark environment to enhance the contrast of the display apparatus. The optical module includes a light guide plate, a light emitting unit arranged at a lateral side of the light guide plate, and an optical film and a scattering film stacked in sequence on the light guide plate, wherein the optical film is configured to reduce an incident angle of incident light and the scattering film is configured to scatter the incident light, the optical film being arranged between the light guide plate and the scattering film.

### CROSS-REFERENCE TO RELATED APPLICATION

This application claims benefit of Chinese Application No. 201410843668.2, filed with SIPO on Dec. 30, 2014, which is incorporated herein by reference in their entirety.

### BACKGROUND OF THE DISCLOSURE

Field of the Disclosure

The present disclosure relates to the technical field of display, and in particular, to an optical module and a reflective display apparatus.

Description of the Related Art

In a reflective LCD (Liquid Crystal Display), a reflective layer is provided below a liquid crystal display panel (i.e., at the side of the liquid crystal layer facing away from its light exit side). With sufficient environmental light, the reflective LCD may achieve its display function by reflected light.

In order to improve the display effects, in prior arts, a light guide plate is provided above the liquid crystal display panel (i.e., at the side of the liquid crystal layer close to its light exit side) and a light emitting unit is provided on a side of the light guide plate, such that the reflective LCD may also achieve its display function even if the environmental light is not sufficient.

### SUMMARY

An embodiment of the present application provides an optical module and a reflective display apparatus, which may improve the display effects in a dark environment and enhance the contrast of the display.

In view of the above, technical solutions of embodiments of the present application are provided as follows.

An embodiment of the present application provides an optical module, including: a light guide plate; a light emitting unit arranged at a lateral side of the light guide plate; and an optical film and a scattering film stacked in sequence on the light guide plate, wherein the optical film is configured to reduce an incident angle of incident light and the scattering film is configured to scatter the incident light, the optical film being arranged between the light guide plate and the scattering film.

In an embodiment, the optical film includes a first optical film layer which includes a first base body and a plurality of first layered parts inside the first base body, the first base body having a refractive index different from that of the first layered parts.

In an embodiment, the plurality of first layered parts are inclined at a same angle and arranged at an angle from 10° to 30° with respect to a normal of the first optical film layer; and the first optical film layer has a scattering center angle from 50° to 90°.

In an embodiment, the optical film further includes a second optical film layer which is arranged between the first optical film layer and the scattering film and includes a second base body and a plurality of second layered parts inside the second base body, the second base body having a refractive index different from that of the second layered parts.

In an embodiment, the plurality of second layered parts are inclined at a same angle and arranged at an angle from 30° to 45° with respect to a normal of the second optical film layer; and the second optical film layer has a scattering center angle from 20° to 50°.

In an embodiment, the scattering film includes a third base body and a plurality of fibrous parts inside the third base body, the third base body having a refractive index different from that of the fibrous parts.

In an embodiment, the plurality of fibrous parts are inclined at a same angle and arranged at an angle from −5° to 10° with respect to a normal of the scattering film; and the scattering film has a scattering center angle from −10° to 20°.

In an embodiment, the optical module further includes a circular polarizer, and the circular polarizer, the optical film and the scattering film are arranged on a same side of the light guide plate.

In an embodiment, the circular polarizer is arranged between the light guide plate and the optical film.

In an embodiment, the light guide plate, the circular polarizer, the optical film and the scattering film are fixed together by adhesives, and wherein the light guide plate has a refractive index greater than that of the adhesive in direct contact with the light guide plate.

An embodiment of the present application provides a reflective display apparatus including a display panel and the optical module according to any one of claims 1-10, wherein the optical module is arranged on a display side of the display panel and the optical film and the scattering film are arranged between the light guide plate and the display panel, the display panel including a reflective layer.

In an embodiment, a light shielding member is provided on lateral sides of the circular polarizer, the optical film and the scattering film of the optical module and the display panel, for sealing the lateral sides.

In an embodiment, the display panel includes an array substrate, and wherein the reflective layer is an opaque electrode layer provided in the array substrate.

Embodiments of the present application provide an optical module and a reflective display apparatus. In view of this, with the optical module provided by the embodiments of the present application, the display function of the reflective LCD may be achieved both in the case that the light is sufficient and in the case that the light is dark. In view of this, when the light emitted by the light emitting unit is used as a display light source, the incident angle of the light entering the display panel may also be reduced efficiently, so as to decrease the probability of the light being absorbed by color films. In this way, the display effects of the reflective LCD in a dark environment may be improved to enhance the contrast of the display apparatus.

### BRIEF DESCRIPTION OF THE DRAWINGS

In order to explain embodiments of the present application or technical solutions in the art more explicitly, the figures showing the embodiments or the prior art will below be illustrated briefly. Apparently, the following figures show only some of embodiments of the present application. It would be appreciated by the skilled person in the art that other figures will also be derived from these figures without any creative efforts.

FIG. 1 is a first schematic view showing a structure of an optical module according to an embodiment of the present application;

FIG. 2 is a second schematic view showing a structure of an optical module according to an embodiment of the present application;

FIG. 3 is a schematic view showing a propagation path of light in an optical module according to an embodiment of the present application;

FIG. 4 is a schematic view showing a structure of an optical film according to an embodiment of the present application;

FIG. 5 is a schematic view showing a structure of another optical film according to an embodiment of the present application;

FIG. 6 is a schematic view showing a structure of a scattering film according to an embodiment of the present application;

FIG. 7 is a third schematic view showing a structure of an optical module according to an embodiment of the present application;

FIG. 8 is a fourth schematic view showing a structure of an optical module according to an embodiment of the present application; and

FIG. 9 is a schematic view showing a structure of a reflective LCD according to an embodiment of the present application.

### DETAILED DESCRIPTION OF EMBODIMENTS

The specific embodiments of the present application will be described clearly and completely with reference to figures. Apparently, the described embodiments are only part of the embodiments of the present application, instead of all of embodiments. On the basis of the embodiments of the present application, the skilled person in the art may derive other embodiments without any creative efforts. All of these other embodiments will fall within the protection scope of the present application.

In addition, for the purpose of explanation, numerous specific details are set forth in the following detailed description to provide a thorough understanding to the embodiments of the present invention. It is obvious, however, that one or more embodiments can also be implemented without these specific details. In other instances, well-known structures and devices are shown in an illustrative manner so as to simplify the drawings.

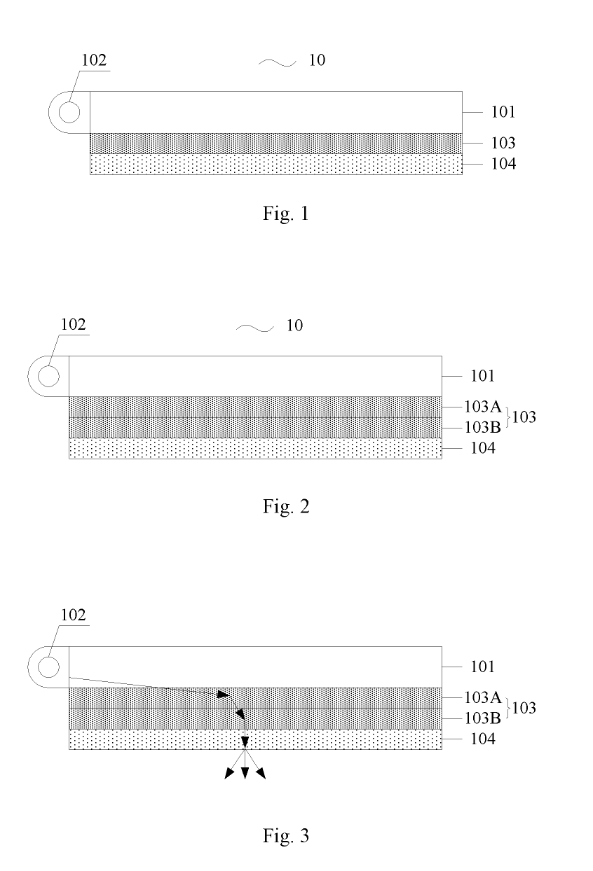

An embodiment of the present application provides an optical module 10. As shown in FIGS. 1-2, the optical module 10 includes: a light guide plate 101, a light emitting unit 102 arranged at a lateral side of the light guide plate 101, and an optical film 103 and a scattering film 104 stacked in sequence on the light guide plate 101. The optical film 103 is configured to reduce an incident angle of incident light and the scattering film 104 is configured to scatter the incident light. The optical film 103 is arranged between the light guide plate 101 and the scattering film 104. As an example, the optical module 10 may be arranged on a display side of a display panel.

In an embodiment of the present application, the optical module 10 is mainly used to provide a front light source for a reflective LCD, in particular suitable for the darker environmental light in comparison with the backlight module of a conventional transmissive LCD.

It should be noted that at first, the light guide plate 101 may have the same structure as that in the conventional transmissive LCD, in particular, it may include a light guide plate body and optical mesh dots arranged on the light guide plate body. Herein it is only required to ensure that the side of the light guide plate 101 on which the optical mesh dots are arranged is located far away from the display panel while the side of the light guide plate 101 on which the optical mesh dots are not arranged is located close to the display panel. In this way, most of light entering the light guide plate 101 can be directed towards one side of the display panel.

Secondly, as the optical module 10 is arranged in the front of the display panel (i.e., on the display side), it needs to ensure all of components in the optical module 10 will not influence normal display of the display panel. In view of this, the light emitting unit 102 needs to be arranged on the lateral side of the light guide plate 101, so as to prevent the normal emission of the exit light from the display panel from being blocked.

In an example, the light emitting unit 102 may be only arranged at one lateral side of the light guide plate 101, or may be arranged on two lateral sides of the light guide plate 101. The light emitting unit 102 may be a LED (Light Emitting Diode) or CCFL (Cold Cathode Fluorescent Lamp). In an embodiment of the present application, the specific type of the light emitting unit 102 is not limited as long as it may provide an illumination light source for the optical film 10.

Thirdly, when the optical module 10 is used in the reflective LCD, it needs to ensure the light entering the display panel is a polarized light, in particular circularly polarized light. In view of this, the polarized light may be formed directly by environmental light entering the optical module 10, or directly by the light emitted from the light emitting unit 102. Alternatively, the polarized light may be formed by converting the light into the polarized light before it enters the display panel. In the embodiments of the present application, the means for forming the polarized light to enter the display panel is not limited.

An embodiment of the present application provides an optical module 10. The optical module 10 may be arranged on a display side of a display panel. The optical module 10 includes: a light guide plate 101, a light emitting unit 102 arranged at a lateral side of the light guide plate 101, and an optical film 103 and a scattering film 104 arranged between the light guide plate 101 and a display panel. The optical film 103 is arranged adjacent to the light guide plate 101 to reduce an incident angle of incident light and the scattering film 104 is arranged adjacent to the display panel to scatter the incident light.

In view of this, in case that the environmental light is sufficient, the light emitting unit 102 is not necessary, and the environmental light is used directly as a display light source. In this circumstance, the environmental light is at first homogenized by the light guide plate 101, and then scattered by the scattering film 104 to enter the display panel. After the incident light reaches the display panel, it will be reflected by a reflective layer in the display panel. The reflected light pass through the scattering film 104 and the light guide plate 101 in sequence, so as to achieve the emission of the light. In this process, as the environmental light is incident on or exits the display panel at a relatively small angle, the optical film 103 will not affect the above light at the small angle.

In case that the environmental light is dark, the light emitted by the light emitting unit 102 is used as a display light source. In this circumstance, the light emitted by the light emitting unit 102 enters the light guide plate 101, and exits from two sides (one side close to the display panel and one side away from the display panel) of the light guide plate 101 after it is homogenized by the light guide plate 101. As shown in FIG. 3, as the light exiting the light guide plate 101 is incident light at a large angle with respect to the display panel, the incident light on the side of the light guide plate 101 close to the display panel needs to pass through the optical film 103 to reduce the incident angle of the light. Then, the light is scattered by the scattering film 104 and enter the display panel. After the incident light reaches the display panel, it will be reflected by the reflective layer in the display panel. The reflected light passes through the scattering film 104 and the light guide plate 101 in sequence, so as to achieve emission of the light. When the reflected light exits the display panel, since the exit light is at a small angle with respect to the display panel, the optical film 103 will affect the exit light no longer. In view of this, it may be known that, with the optical module 10 provided by the embodiment of the present application, the display function of the reflective LCD may be achieved both in the case that the light is sufficient and in the case that the light is dark. In view of this, when the light emitted by the light emitting unit 102 is used as a display light source, the incident angle of the light entering the display panel may also be reduced efficiently, so as to decrease the probability of the light being absorbed by color films. In this way, the display effects of the reflective LCD in the dark environment may be improved to enhance the contrast of the display apparatus.

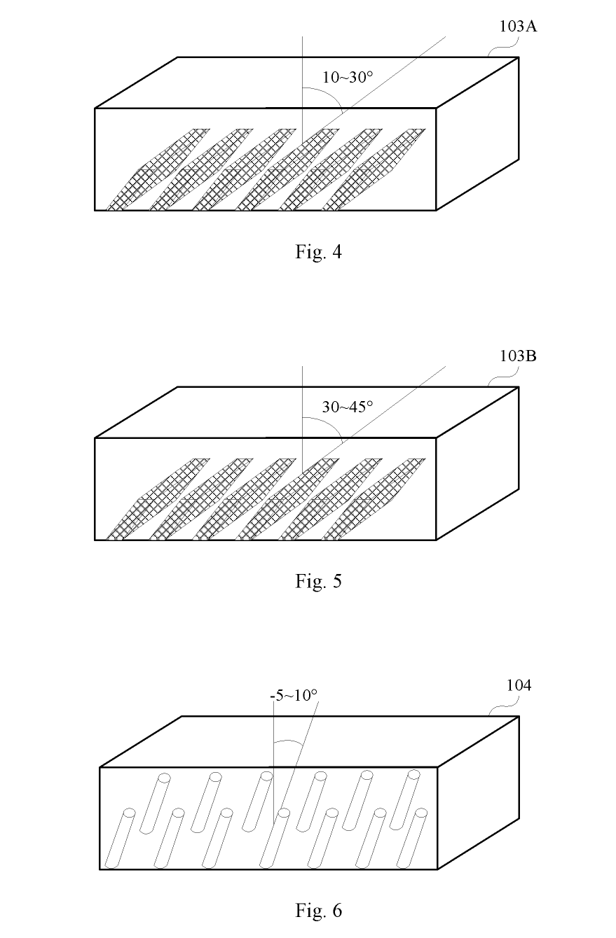

In an example, the optical film 103 may include a first optical film layer 103A. As illustrated in FIG. 4, the first optical film layer 103A includes a first base body and a plurality of first layered parts inside the first base body, the first base body having a refractive index different from that of the first layered parts. The difference between the refractive index of the first base body and the refractive index of the first layered parts is in a range of 0 to 1 and preferably is set as large as possible.

In an example, the first base body and the first layered parts may be made from two types of acrylic ester materials respectively. The molecule mass of the acrylic ester material for forming the first base body is different from that of the acrylic ester material for forming the first layered parts.

The material of the first base body may for example be ethoxy phenyl phenol acrylate with a large refractive index having the following molecular constitution:

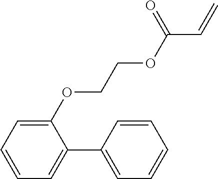 [SMILES: C=CC(=O)OCCOc1ccccc1-c1ccccc1]

The material of the first layered parts may for example be polyurethane acrylate oligomer with a low refractive index having the following molecular constitution:

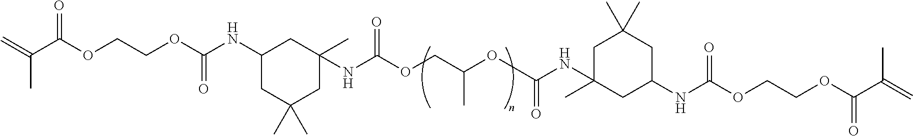

Based on the above, the plurality of first layered parts are inclined at a same angle and at an angle from 10° to 30° with respect to a normal of the first optical film layer 103A; and the first optical film layer 103A has a scattering center angle from 50° to 90°.

In this way, after the light emitted from the light guide plate 101 to the display panel passes through the first optical film layer 103A, the incident angle of the light may be reduced efficiently, such that the light is incident on the display panel as close to the normal as possible.

In a further embodiment, the optical film 103 may further include a second optical film layer 103B which is arranged between the first optical film layer 103A and the scattering film 104. As shown in FIG. 5, the second optical film layer includes a second base body and a plurality of second layered parts inside the second base body, the second base body having a refractive index different from that of the second layered parts. The difference between the refractive index of the second base body and the refractive index of the second layered parts is in a range of 0 to 1 and preferably is set as large as possible.

In an example, the second base body and the second layered parts may be made from two types of acrylic ester materials respectively. The molecule mass of the acrylic ester material for forming the second base body is different from that of the acrylic ester material for forming the second layered parts. The examples of their molecular constitutions may be the same as those for the first base body and the first layered parts, as discussed above. The details for their molecular constitutions will be omitted herein.

In view of this, the plurality of second layered parts are inclined at a same angle and at an angle from 30° to 45° with respect to a normal of the second optical film layer 103B; and the second optical film layer 103B has a scattering center angle from 20° to 50°. In this way, after the light emitted from the light guide plate 101 to the display panel passes through the second optical film layer 103B, the incident angle of the light may be reduced efficiently, such that the light is incident on the display panel as close to the normal as possible.

As an example, as illustrated in FIG. 6, the scattering film 104 may includes a third base body and a plurality of fibrous parts inside the third base body, the third base body having a refractive index different from the fibrous parts. The difference between the refractive index of the third base body and the refractive index of the fibrous parts is in a range of 0 to 1 and preferably is set as large as possible.

In an example, the third base body and the fibrous parts may be made from two types of acrylic ester materials respectively. The molecule mass of the acrylic ester material for forming the third base body is different from that of the acrylic ester material for forming the fibrous parts. The examples of their molecular constitutions may be the same as those for the first base body and the first layered parts, as discussed above. The details for their molecular constitutions will be omitted herein.

In view of this, the plurality of fibrous parts are inclined at a same angle and at an angle from −5° to 10° with respect to a normal of the scattering film 104 (for example, with respect to a direction perpendicular to the scattering film 104); and the scattering film 104 has a scattering center angle from −10° to 20°.

In this way, the light that passes through the optical film 103 and then is scattered by the scattering film 104 to the display panel may form homogenized incident light with a small incident angle.

It should be noted that thicknesses of the optical film 103 and the scattering film 104 preferably are as small as possible. However, due to limitation of producing process, the conventional thicknesses of the optical film 103 and the scattering film 104 typically are less than or equal to 200 μm.

On the basis of the above description, the propagation path of the incident light will be explained in details below with reference to FIG. 3. As an example, the initial light emitted from the light guide plate 101 to the display panel is incident light with a large incident angle, for example, with an incident angle of 80°. After the light passes through the first optical film layer 103A, the above incident angle is reduced to for example 60°. After it passes through the second optical film layer 103B, the above incident angle is further reduced to for example 30°. In this way, the incident light with a large incident angle will be converted into an incident light with a small incident angle. The light may be incident on the display panel 20 (below the scattering film 104) directly after it has been scattered by the scattering film 104. Thus, provision of the optical film 103 may reduce the incident angle of the light efficiently. In view of this, the optical film may not influence the exit light at any ways.

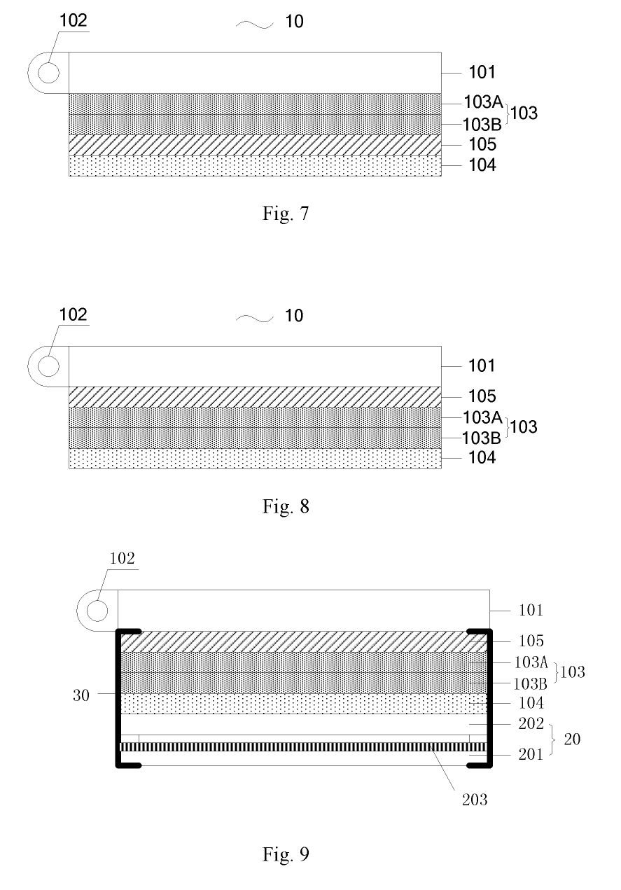

In an example, as shown in FIGS. 7-8, the optical module 10 may further include a circular polarizer 105. The circular polarizer 105, the optical film 103 and the scattering film 104 are arranged on the same side of the light guide plate. For example, the circular polarizer 105 is arranged on the side of the light guide plate 101 close to the display panel.

As an example, the circular polarizer 105 may be arranged at any position between the light guide plate 101 and the display panel, for example, between the light guide plate 101 and the optical film 103, or between the optical film 103 and the scattering film 104, or between the scattering film 103 and the display panel. On the basis of this, when the optical film 103 includes both the first optical film layer 103A and the second optical film layer 103B, the circular polarizer 105 may further be arranged between the first optical film layer 103A and the second optical film layer 103B.

Considering that the light emitting unit 102 is arranged at the lateral side of the light guide plate 101, i.e., the light enters the optical module 10 from the lateral side of the light guide plate 101, as an example, the circular polarizer 105 is provided between the light guide plate 101 and the optical film 103 so as to ensure all of light finally becomes circularly polarized light as possible before entering the display panel.

In view of this, as an example, the light guide plate 101, the circular polarizer 105, the optical film 103 and the scattering film 104 are fixed together by adhesive(s).

As an example, the light guide plate 101 has a refractive index greater than that of the adhesive in direct contact with the light guide plate 101.

In particular, if the refractive index of the light guide plate 101 is greater than that of the adhesive in contact with the light guide plate 101, the light may be totally internally reflected in the light guide plate 101 to enhance the total reflectivity of the light. In this way, the light that has been reflected at multiple times will have high optical efficiency and good homogeneousness.

An embodiment of the present application also provides a reflective display apparatus. As shown in FIG. 9, the reflective display apparatus includes a display panel 20 and the optical module 10 as described above. The optical module 10 is arranged on a display side of the display panel 20 and the optical film 103 and the scattering film 104 are arranged between the light guide plate 101 and the display panel 20, the display panel 20 including a reflective layer 203.

In an example, the display panel 20 may include an array substrate 201, a color filter substrate 202 and a liquid crystal layer between them.

In an example, the above reflective layer 203 may be an opaque electrode layer, for example, a pixel electrode layer, arranged in the array substrate 201.

In particular, the light emitted from the light guide plate 101 to the display panel 20 will become a circularly polarized light, for example a left-handed polarized light, after it passes through the circular polarizer 105. The left-handed polarized light passes through the liquid crystal layer, the reflective layer and the liquid crystal layer in sequence and its polarization will change correspondingly, such that the resultant exit light is selectively transmitted through the circular polarizer 105 depending on its actual polarization.

Thus, the reflective layer 203 needs to be arranged on a side of the array substrate 201, i.e., on the side of the liquid crystal layer facing away from the light guide plate 101. Certainly, the reflective layer may not be an electrode layer as long as it may reflect the light and be arranged on the side of the array substrate 201.

In an example, a light shielding member 30 is provided on lateral sides of the circular polarizer 105, the optical film 103 and the scattering film 104 of the optical module 10 and the display panel 20, for sealing the lateral sides.

In an example, the light shielding member 30 may be black photoresist.

Here, if the light shielding member 30 is not provided, the light emitted into the lateral side may not pass through the light guide plate 101, but be emitted into the optical module 10, even into the display panel 20, from the lateral side, which may result in reduction in the contrast of the reflective LCD.

In view of this, by providing the light shielding member 30 on the lateral sides of the circular polarizer 105, the optical film 103 and the scattering film 104 of the optical module 10 and the display panel 20, the lateral sides of all of the layers of the reflective LCD other than the light guide plate 101 are covered. In this way, it may completely avoid the light from entering from the lateral sides, so as to enhance the contrast of the reflective LCD.

The above embodiments are only examples of the present application, but the protection range of the present application is not limited to this. It would be appreciated by those skilled in the art that various modifications or alternations of the above embodiments within the scope of the present disclosure will also fall within the scope of the present application. The scope of the present application is defined by the appended claims.

1. An optical module, comprising:
a light guide plate;
a light emitting unit arranged at a lateral side of the light guide plate; and
an optical film and a scattering film stacked in sequence on the light guide plate,
wherein the optical film is configured to reduce an incident angle of incident light and the scattering film is configured to scatter the incident light, the optical film being arranged between the light guide plate and the scattering film.

2. The optical module according to claim 1, wherein the optical film comprises a first optical film layer which comprises a first base body and a plurality of first layered parts inside the first base body, the first base body having a refractive index different from that of the first layered parts.

3. The optical module according to claim 2, wherein the plurality of first layered parts are inclined at a same angle and arranged at an angle from 10° to 30° with respect to a normal of the first optical film layer; and the first optical film layer has a scattering center angle from 50° to 90°.

4. The optical module according to claim 2, wherein the optical film further comprises a second optical film layer which is arranged between the first optical film layer and the scattering film and comprises a second base body and a plurality of second layered parts inside the second base body, the second base body having a refractive index different from that of the second layered parts.

5. The optical module according to claim 4, wherein the plurality of second layered parts are inclined at a same angle and arranged at an angle from 30° to 45° with respect to a normal of the second optical film layer; and the second optical film layer has a scattering center angle from 20° to 50°.

6. The optical module according to claim 1, wherein the scattering film comprises a third base body and a plurality of fibrous parts inside the third base body, the third base body having a refractive index different from that of the fibrous parts.

7. The optical module according to claim 6, wherein the plurality of fibrous parts are inclined at a same angle and arranged at an angle from −5° to 10° with respect to a normal of the scattering film; and the scattering film has a scattering center angle from −10° to 20°.

8. The optical module according to claim 1, further comprising a circular polarizer, and the circular polarizer, the optical film and the scattering film are arranged on a same side of the light guide plate.

9. The optical module according to claim 8, wherein the circular polarizer is arranged between the light guide plate and the optical film.

10. The optical module according to claim 8, wherein the light guide plate, the circular polarizer, the optical film and the scattering film are fixed together by adhesives, and wherein the light guide plate has a refractive index greater than that of the adhesive in direct contact with the light guide plate.

11. A reflective display apparatus comprising a display panel and the optical module according to claim 1, wherein the optical module is arranged on a display side of the display panel and the optical film and the scattering film are arranged between the light guide plate and the display panel, the display panel comprising a reflective layer.

12. The display apparatus according to claim 11, wherein a light shielding member is provided on lateral sides of the circular polarizer, the optical film and the scattering film of the optical module and the display panel, for sealing the lateral sides.

13. The display apparatus according to claim 11, wherein the display panel comprises an array substrate, and wherein the reflective layer is an opaque electrode layer provided in the array substrate.

14. The display apparatus according to claim 11, wherein the optical film comprises a first optical film layer which comprises a first base body and a plurality of first layered parts inside the first base body, the first base body having a refractive index different from that of the first layered parts.

15. The display apparatus according to claim 14, wherein the plurality of first layered parts are inclined at a same angle and arranged at an angle from 10° to 30° with respect to a normal of the first optical film layer; and the first optical film layer has a scattering center angle from 50° to 90°.

16. The display apparatus according to claim 14, wherein the optical film further comprises a second optical film layer which is arranged between the first optical film layer and the scattering film and comprises a second base body and a plurality of second layered parts inside the second base body, the second base body having a refractive index different from that of the second layered parts.

17. The display apparatus according to claim 16, wherein the plurality of second layered parts are inclined at a same angle and arranged at an angle from 30° to 45° with respect to a normal of the second optical film layer; and the second optical film layer has a scattering center angle from 20° to 50°.

18. The display apparatus according to claim 11, wherein the scattering film comprises a third base body and a plurality of fibrous parts inside the third base body, the third base body having a refractive index different from that of the fibrous parts.

19. The display apparatus according to claim 18, wherein the plurality of fibrous parts are inclined at a same angle and arranged at an angle from −5° to 10° with respect to a normal of the scattering film; and the scattering film has a scattering center angle from −10° to 20°.

20. The display apparatus according to claim 11, wherein the optical module further comprises a circular polarizer, and the circular polarizer, the optical film and the scattering film are arranged on a same side of the light guide plate.
